(19) United States
(12) Patent Application Publication
(10) Pub. No.: US 2007/0223765 A1
(43) Pub. Date: Sep. 27, 2007

(54) Wireless headset adjustable for either ear

(75) Inventor: Tai-Chang Wang, Taipei (TW)

Correspondence Address: BIRCH STEWART KOLASCH & BIRCH, PO BOX 747, FALLS CHURCH, VA, 22040-0747, US

(73) Assignee: Bluedect Technology Corp.

(21) Appl. No.: 11/373,245

(22) Filed: Mar. 13, 2006

(51) Int. Cl. H04R 25/00

(52) U.S. Cl. 381/374; 381/381; 381/379

(57) ABSTRACT

A single-ear wireless headset is provided herein, which mainly contains a body member, an arm member, a hook member, and a joint member having a twisting element. On the two sides of the body member, two radially opposing connecting holes are provided for the connection to the joint member and the arm member respectively. The joint member in turn houses a leg of the L-shaped twisting element whose other leg is embedded inside the hook member. Because of the configuration of the twisting element, the hook member can be swung around the joint member for wearing on a user's either left or right ear, without altering the orientation of the ornament features on the body member and the hook member.

### BACKGROUND OF THE INVENTION

1. Field of the Invention

The present invention relates wireless headsets, and more particularly to a single-ear wireless headset whose hook member is adjustable for wearing on either left or right ear.

2. The Prior Arts

Various kinds of earphone and microphone devices have been commonly seen and used in daily life. Especially in recent years with the widespread popularity of mobile electronics devices such as cellular phones and PDAs, wireless headsets integrating both earphone and microphone have become one of the most important accessories for mobile electronic devices.

Currently, most wireless headsets for cellular phones have been structured for wearing on a single ear and have the so-called “over-the-ear” design. An over-the-ear headset has a hook member that curves to run from the front to the back of the ear for positioning the earphone and the microphone of the headset appropriately. Even though most of the over-the-ear headsets are adjustable for wearing over the user's either left or right ear, the adjustment is usually not convenient, especially when the user is on the move or is driving. In addition, the ornament features such as pattern, text, logo, and trademark on the headset are inverted when the headset is adjusted for the other ear. A conventional wireless headset also usually has the microphone configured on an end of an elongated arm so that the microphone is positioned closer to the user's mouth. However, the conventional wireless headsets are not flexibly designed to allow a user to adjust the relative locations of the earphone and the microphone to fit the user's specific facial feature.

### SUMMARY OF THE INVENTION

Accordingly, a novel wireless headset is provided herein to obviate the inflexibility problems of the conventional designs.

A major objective of the present invention is to allow the wireless headset to be easily and conveniently switched from the configuration for one ear to the configuration for the other ear without altering the orientation of the ornament features on the wireless headset.

To achieve the foregoing objective, the present invention forms a body member by joining two corresponding casing pieces. One of the casing pieces has a bulging ear portion in the center on an outer side, and an indentation with a connecting hole for the connection to a joint member along the circumference of the casing piece.

The joint member is formed by joining two corresponding casing pieces. One of the casing pieces has a cylindrical locking portion extended from an outer side. The locking portion has a number of protruding ear elements for squeezing into the connecting hole of the body member so that the joint member is reliably connected to the body member. The two casing pieces of the joint member also form a closed space for housing a twisting element.

The twisting element has an L shape whose one leg is housed inside the joint member and whose other leg is embedded inside a hook member respectively. The connections between the body member and the joint member and between the joint member and the twisting element allow them to rotate relative to each other. As such, the hook member can be swung towards or away from the body member for mounting or removing the present invention to or from a user's ear, and for adjusting the tightness of the hook member's clinging to the user's user. Because of the configuration of the twisting element, the hook member can also be swung for 180 degrees around the joint member for wearing on a user's either left or right ear, therefore allowing the present invention to be adjusted for either ear easily and conveniently.

The other casing piece of the body member has a connecting hole along the circumference on an outer side radially opposite to the connecting hole on the other casing piece for the connection to a locking portion on an end of an elongated arm member having a mouth port on the other end. The connection between the arm member and the body member allows them to rotate relative to each other. As such, the location of the mouth port of the arm member can be adjusted to fit a user's specific requirement.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a perspective and exploded view showing a wireless headset according to an embodiment of the present invention.

FIG. 2 is a perspective and exploded view showing the joint member of the wireless headset of FIG. 1.

FIG. 3 is a perspective view showing the wireless headset of FIG. 1 after its assembly.

FIG. 4A is a profile view showing the wireless headset of FIG. 1 in a configuration for wearing on the right ear.

FIG. 4B is a profile view showing the wireless headset of FIG. 1 in a configuration for wearing on the left ear.

FIG. 5 is a profile view showing the wireless headset of FIG. 1 when the arm member is adjusted.

FIG. 6A is a schematic view showing the wireless headset of FIG. 1 is worn on a user's left ear.

FIG. 6B is a schematic view showing the wireless headset of FIG. 1 is worn on a user's right ear.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

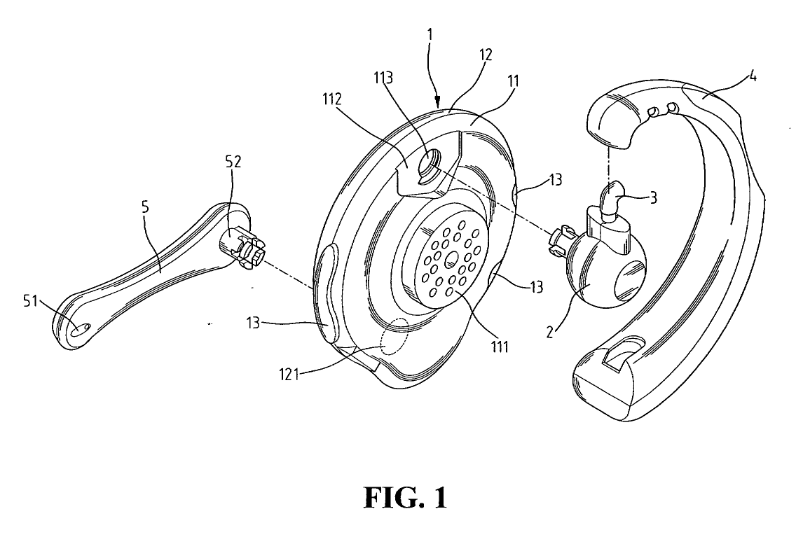

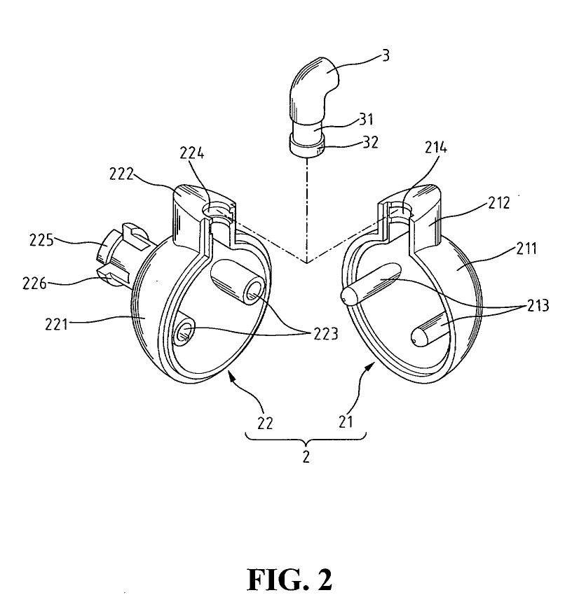

As shown in FIGS. 1 and 2, a single-year wireless headset according to an embodiment of the present invention mainly contains an body member 1, a joint member 2 having a twisting element 3, a hook member 4, and an arm member 5. Please note that the subject matter of the present invention lies in the physical structure of the wireless headset. The electronic components housed inside, the mobile electronic devices that run with the wireless headset of the present invention, and the communications protocol supported (e.g., Bluetooth®) can be any of those currently known or future developed.

The substantially flat body member 1 is assembled by joining two corresponding and substantially circular casing pieces 11 and 12. The casing piece 11 has an ear portion 111 bulged in the center from an outer side of the casing piece 11 opposite to the inner side facing the other casing piece 12. An indentation 112 is provided at an appropriate location along the circumference next to the ear portion 111 on the outer side of the casing piece 11. Within the indentation 112, a connecting hole 113 is provided. Please note that the casing piece 12 does not have a corresponding opening so that the connecting hole 113 does not run through the body member 1. At the interface where the casing pieces 11 and 12 are joined, at least a control button 13 is provided for functions such as adjusting volume of the headset. On an outer side (i.e., the side facing away from the casing piece 11) of the casing piece 12, another connecting hole 121 is provided at an appropriate location radially opposite to that of the connecting hole 113. Similarly, the connecting hole 121 does not run through the body member 1.

The joint member 2 has a substantially spherical shape and is assembled by joining two corresponding casing pieces 21 and 22. The casing pieces 21 and 22 have substantially semispherical portions 211 and 221 respectively. In one of the semispherical portion (e.g., 211 of the present embodiment), two elongated plugs 213 are extended from the inner side (i.e., the side facing towards the other semispherical piece). Correspondingly, the other semispherical portion (i.e., 221 in the present embodiment) has two sockets 223 for receiving the plugs 213. At appropriate and corresponding locations along the circumference of the semispherical portions 211 and 221, housing sections 212 and 222 are extended respectively. The interiors of the housing sections 212 and 222 are partitioned to form grooves 214 and 224.

One of the casing pieces (i.e., 22 in the present embodiment) has a cylindrical locking portion 225 extended near the center from the outer side. From the cylindrical surface at the outer end of the locking portion 225, a number of flexible and protruding ear elements 226 are evenly spaced. The connection of the joint member 2 to the body member 1 is achieved by squeezing the ear elements 226 of the locking portion 225 into the connecting hole 113. Once the squeezed ear elements 226 have passed through the connecting hole 113, the ear elements 226 are restored to their original size so as to lock the joint member 2 reliably to the body member 1. Please note that the connection of the joint member 2 and the body member 1 is left with some leeway so that the joint member 2 is able to spin within the indentation 112 of the body member 1.

The twisting element 3 has an L-shape cylindrical body. At the end of one of its legs (hereinafter, the first leg) of the twisting element 3, a groove 31 is formed around the cylindrical outer surface, leaving a circular bank 32 between the groove 31 and the end of the first leg. The connection of the twisting element 3 to the joint member 2 is achieved by positioning the circular bank 32 of the first leg inside the grooves 214 and 224 when the casing pieces 21 and 22 are joined together. As such, the circular bank 32 of the twisting element 3 is wrapped inside the space formed by the grooves 214 and 224. Again, some leeway is reserved so that the twisting element 3 is able to rotate pivotally around its first leg. The other leg (hereinafter, the second leg) of the twisting element 3 is embedded inside an end of the hook member 4 and, therefore, the hook member 4 can be rotated along with the twisting element 3.

The arm member 5 has an elongated body with a mouth port 51 at one end and a cylindrical locking portion 52 at the other end. The structure of the locking portion 52 and its connection to the connecting hole 121 of the body member 1 are identical to those of the locking portion 225 of the joint member 2, and the details about the locking portion 52 are therefore omitted here.

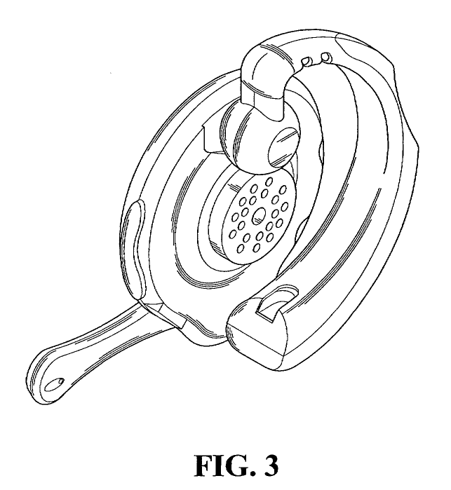

The complete assembly of the wireless headset of the present embodiment is shown in FIG. 3. As illustrated, the two legs of the twisting element 3 are housed inside the joint member 2 and the hook member 4 respectively and, therefore, the twisting element 3 is not visible from the outside of the present embodiment.

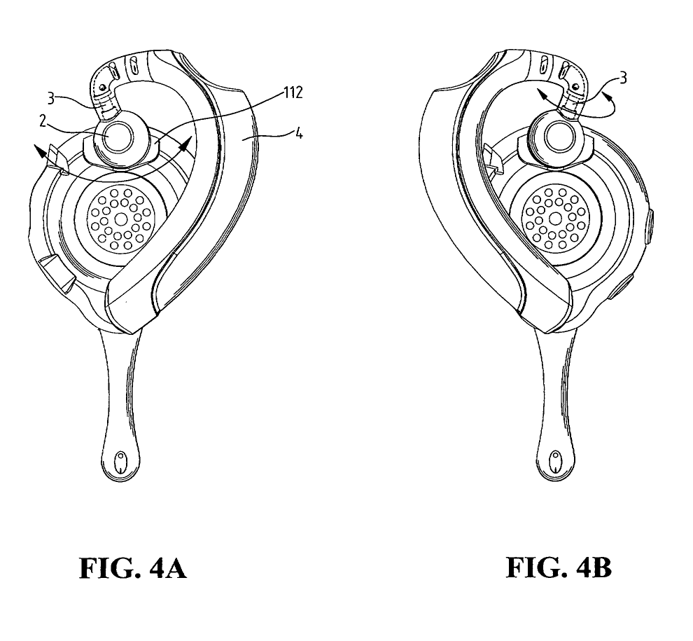

As shown in FIG. 4A, the joint member 2 can be rotated pivotally around its locking portion 225 inside the indentation 112 so that the hook member 4 can be swung towards or away from the body member 1. When the hook member 4 is swung away from the body member 1, the present embodiment can be easily positioned over or removed from an ear. Once the hook member 4 is placed over the ear, the relative location of the hook member 4 and the body member 1 can be adjusted according to the user's will. The hook member 4 and the body member 1 can be adjusted to be close to each other so that the present embodiment is tightly fitted over the ear when the user is on the move, or they can be appropriately separated to relieve the tension of the ear and to enhance the user's wearing comfort.

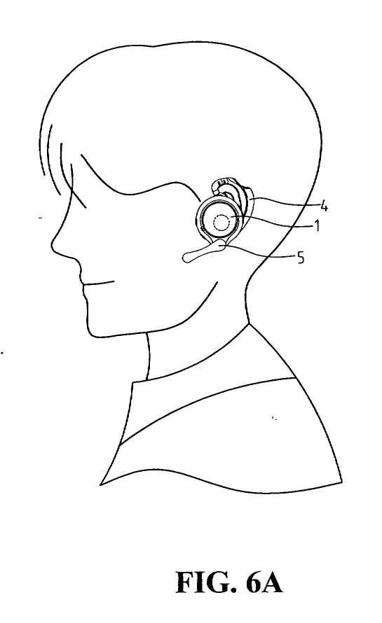

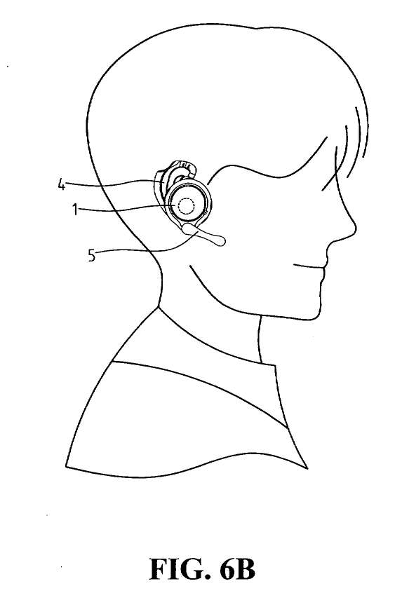

Because of the configuration of the twisting element 3, a user can easily adjust the hook member 4 for wearing either on left or right ear with a single hand and even when the user is on the move without altering the orientation of the ornament features on the body member 1 and the arm member 5. For example, what is shown in FIG. 4A is a configuration for wearing the present embodiment on the right ear. Then, by swing the hook member 4 pivotally around the first leg of the twisting element 3 for 180 degree to the other side, the present embodiment is in a configuration for wearing on the left ear, as shown in FIG. 4B. FIGS. 6A and 6B show the two scenarios when the present embodiment is worn on a user's left and right ears respectively.

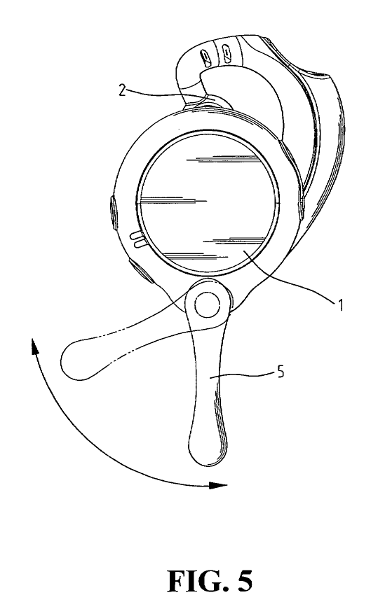

As mentioned earlier, some leeway is reserved at the connection of the arm member 5 to the body member 1 so that, as shown in FIG. 5, the arm member 5 can be swung pivotally around its locking portion 52 so that a user can adjust the location of the mouth port 51 to fit his or her specific needs.

In alternative embodiments, the body member 1 and the joint member 2 can also be molded into a single object, instead of being assembled by two pieces. In order to enhance the operation life of the present invention, the moving parts such as the locking portion 52 of the arm member 5 and the other parts' junction to the moving parts should be made of a flexible and robust material such as rubber so as to withstand the wear of a large number of turns and spins.

In an alternative embodiment, the joint member 2 can be implemented to have an L-shaped cylindrical body, instead of having a spherical body as in the previous embodiment. A leg of the L-shaped body is just like the locking portion 225 in the previous embodiment for joining to the connecting hole 113 of the body member 1, and the other leg is the combination of the housing sections 212 and 222 for receiving the twisting element 3.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless headset, comprising:
a substantially flat body member having an ear portion bulging from a first side of said body member;
a joint member pivotally joined to said body member at an appropriate location along the circumference of said body member next to said ear portion, said joint member having a twisting element with two ends, a first end of said twisting element being pivotally joined to said joint member at an appropriate location perpendicular to the connection between said joint member and said body member;
an elongated arm member whose one end is pivotally joined to a second side of said body member facing away from said first side; and
a hook member fixedly joined to a second end of said twisting element so that said hook member can pivot around said joint member via said twisting element;
wherein, when said wireless headset is worn over a user's ear, said hook member runs over and behind said ear; and said ear portion of said body member is positioned next to the canal of said ear.

2. The wireless headset according to claim 1, wherein said body member has an indentation at an appropriate location on said first side along the circumference of said body member next to said ear portion; said indentation has a first connecting hole inside for receiving a connector of said joint member; said body member has a second connecting hole on said second side radially opposite to said first connecting hole for receiving a connector of said arm member.

3. The wireless headset according to claim 1, wherein said twisting element has an L shape whose first leg is pivotally joined to said joint member and a second leg is embedded inside an end of said hook member.

4. The method according to claim 3, wherein said first leg of said twisting element has a groove around said first leg, forming a bank between said groove and the end of said first leg; said joint member is formed by joining two corresponding casing pieces; said casing pieces forms a housing with an opening surrounding said groove and receives said bank of said twisting element inside so that said twisting element is able to pivot around said joint member.

5. The method according to claim 2, wherein said connector of said joint member has a substantially cylindrical body extended from a side of said joint member; and said connector has a plurality of ear elements around the outer surface at the end of said cylindrical body.

6. The method according to claim 2, wherein said connector of said arm member has a substantially cylindrical body extended from said end of said arm member; and said connector has a plurality of ear elements around the outer surface at the end of said cylindrical body.

7. The wireless headset according to claim 1, wherein said body member is formed by joining two substantially circular and corresponding casing pieces.

8. The wireless headset according to claim 4, wherein said casing pieces are substantially semispherical; one of said casing pieces has at least an elongated plug extended from the inner side of said casing piece; and the other casing pieces has a corresponding socket extended from the inner side for receiving said plug.

9. The wireless headset according to claim 1, wherein said arm member has a mouth port at the other end.

10. The wireless headset according to claim 2, wherein said joint member has an L-shaped cylindrical body whose one leg functioning as said connector has a plurality of ear elements around the outer surface at the end, and whose the other leg receives said first end of said twisting element.
